(19) United States
(12) Patent Application Publication
(10) Pub. No.: US 2024/0394418 A1
(43) Pub. Date: Nov. 28, 2024

(54) DETECTING ATTACKS ON POWER SUPPLIES BY COMPARING TWO SHIFT REGISTERS

(71) Applicant: Groq, Inc., Mountain View, CA (US)

(72) Inventor: James Sproch, MONTE SERENO, CA (US)

(21) Appl. No.: 18/667,887

(22) Filed: May 17, 2024

Related U.S. Application Data
(60) Provisional application No. 63/503,595, filed on May 22, 2023.

(51) Int. Cl. G06F 21/75; G06F 21/57

(52) U.S. Cl. CPC G06F 21/755; G06F 21/575

(57) ABSTRACT

Described are embodiments related to counter threat vector. A system includes two Linear Feedback Shift Registers (LFSR) of an equal size in the number of bits, initialized at power up or reset to an initial condition, wherein the values of the two LFSRs are compared during each clock cycle and if there is a mismatch an error is reported and threat mitigation initiated. This Abstract and the independent Claims are concise signifiers of embodiments of the claimed inventions. The Abstract does not limit the scope of the claimed inventions.

### CROSS-REFERENCE TO RELATED APPLICATIONS

This application claims the benefit of priority to U.S. Provisional Application No. 63/503,595, filed May 22, 2023, and entitled “Counter Threat Vector,” the entirety of which is expressly incorporated herein by reference.

### COPYRIGHT NOTICE

This patent document can be exactly reproduced as it appears in the files of the United States Patent and Trademark Office, but the assignee(s) otherwise reserves all rights in any subsets of included original works of authorship in this document protected by 17 USC 102 (a) of the U.S. copyright law.

### SPECIFICATION—DISCLAIMERS

In the following Background, Summary, and Detailed Description, paragraph headings are signifiers that do not limit the scope of an embodiment of a claimed invention (ECIN). The citation or identification of any publication signifies neither relevance nor use as prior art. A paragraph for which the font is all italicized signifies text that exists in one or more patent specifications filed by the assignee(s).

A writing enclosed in double quotes (“ ”) signifies an exact copy of a writing that has been expressed as a work of authorship. Signifiers, such as a word or a phrase enclosed in single quotes (‘ ’), signify a term that as of yet has not been defined and that has no meaning to be evaluated for, or has no meaning in that specific use (for example, when the quoted term ‘module’ is first used) until defined.

### FIELD(S) OF TECHNOLOGY

This disclosure has general significance in the field of power management in processors, in particular, the synthesis of clock waveforms for more efficient power management in high-speed processors. This information is limited to use in the searching of the prior art.

### BACKGROUND

A foundational requirement for secure operation is a guarantee that an Integrated Circuit (IC, or chip) is securely initialized after powerup, and hardened against attacks that exploit power supply disruptions.

Power supply disruption, including cycling power completely on and off, or partially reducing power below minimum required operating conditions, constitutes a vexing security attack. An example attack is as easy as powering the device on and off enough times that the randomly-induced initial state of the device allows access to information that should otherwise be inaccessible. Other attacks use voltage glitching to inject faults, for example as described in this reference: [One Glitch to Rule Them All: Fault Injection Attacks Against AMD's Secure Encrypted Virtualization, Buhren, Jacob, Krachenfels, and Seifert (2021)], which is incorporated herein by reference. Some attacks use voltage glitching to improperly manipulate chip signals such as clocks and resets in conjunction with power disruption events to circumvent particular protective measures. Power supplies can be crow-bared (short-circuited) or voltage regulators can be reprogrammed via software control using dynamic voltage and frequency scaling (DVFS) facilities. Security attacks such as these require generalized barriers as a defense against hackers intent on finding unpredicted new vulnerabilities. Narrowly targeted countermeasures against a specific attack alone may be inadequate.

What others have failed to enable is for an integrated circuit, such as a high-speed processor, to be able to self-defect these security attacks.

### SUMMARY

This Summary, together with any Claims, is a brief set of signifiers for at least one ECIN (which can be a discovery, see 35 USC 100 (a); and see 35 USC 100 (j)), for use in commerce for which the Specification and Drawings satisfy 35 USC 112.

In one or more ECINs disclosed herein, methods, systems, and other embodiments to ensure secure operation of an integrated circuit (IC) are enabled that securely initialize the IC after the powerup, and harden the IC against attacks that exploit power glitch events.

In one or more ECINs disclosed herein, a system comprises two Linear Feedback Shift Registers (LFSR) of an equal size in the number of bits that are initialized at power up or reset to an initial condition. The values of the two LFSRs are compared during each clock cycle, and if there is a mismatch, an error is reported and threat mitigation initiated.

In one or more ECINs disclosed herein, a system comprises one Linear Feedback Shift Register (LFSR) and one binary counter of an equal size in the number of bits, initialized at power up or reset to an initial condition. During each anchor timestamp listed in a table of anchor timestamps and expected values, the values of the LFSR is compared to the expected value from the table. If there is a mismatch an error is reported and threat mitigation initiated.

In one or more ECINs disclosed herein, a system that comprises two Linear Feedback Shift Register (LFSR) blocks and one binary counter block, all three blocks having an equal size in the number of bits, initialized at power up or reset to an initial condition. The values of the two LFSRs are compared during each clock cycle and if there is a mismatch an error is reported and threat mitigation initiated. Also, during each anchor timestamp listed in a table of anchor timestamps and expected values, the value of either LFSR is compared to the expected value from the table. If there is a mismatch an error is reported and threat mitigation initiated.

This Summary does not completely signify any ECIN. While this Summary can signify at least one essential element of an ECIN enabled by the Specification and Figures, the Summary does not signify any limitation in the scope of any ECIN.

### BRIEF DESCRIPTION OF DRAWINGS

The following Detailed Description, Figures, and Claims signify the uses of and progress enabled by one or more ECINs. All of the Figures are used only to provide knowledge and understanding and do not limit the scope of any ECIN. Such Figures are not necessarily drawn to scale.

FIG. 1 illustrates a system for compiling programs to be executed on a tensor processor according to one or more embodiments described herein.

FIGS. 2A and 2B illustrate instruction and data flow in a processor having a functional slice architecture according to one or more embodiments described herein.

FIG. 3 illustrates a system that facilitates detection of attacks on power supplies according to one or more embodiments described herein.

FIG. 4 illustrates another system that facilitates threat mitigation for integrated circuits according to one or more embodiments described herein.

FIG. 5 illustrates a computer-implemented method that facilitates threat mitigation using anchor times according to one or more embodiments described herein.

FIG. 6 illustrates a computer-implemented method that facilitates threat mitigation using clock cycles according to one or more embodiments described herein.

FIG. 7 illustrates a computer system suitable for enabling embodiments of the one or more embodiments described herein.

FIG. 8 illustrates another computer system suitable for enabling embodiments of the one or more embodiments described herein.

The Figures can have the same, or similar, reference signifiers in the form of labels (such as alphanumeric symbols, e.g., reference numerals), and can signify a similar or equivalent function or use. Further, reference signifiers of the same type can be distinguished by appending to the reference label a dash and a second label that distinguishes among the similar signifiers. If only the first label is used in the Specification, its use applies to any similar component having the same label irrespective of any other reference labels. A brief list of the Figures is below.

In the Figures, reference signs can be omitted as is consistent with accepted engineering practice; however, a skilled person will understand that the illustrated components are understood in the context of the Figures as a whole, of the accompanying writings about such Figures, and of the embodiments of the claimed inventions.

### DETAILED DESCRIPTION

The Figures and Detailed Description, only to provide knowledge and understanding, signify at least one ECIN. To minimize the length of the Detailed Description, while various features, structures or characteristics can be described together in a single embodiment, they also can be used in other embodiments without being written about. Variations of any of these elements, and modules, processes, machines, systems, manufactures, or compositions disclosed by such embodiments and/or examples are easily used in commerce. The Figures and Detailed Description signify, implicitly or explicitly, advantages and improvements of at least one ECIN for use in commerce.

In the Figures and Detailed Description, numerous specific details can be described to enable at least one ECIN. Any embodiment disclosed herein signifies a tangible form of a claimed invention. To not diminish the significance of the embodiments and/or examples in this Detailed Description, some elements that are known to a skilled person can be combined together for presentation and for illustration purposes and not be specified in detail. To not diminish the significance of these embodiments and/or examples, some well-known processes, machines, systems, manufactures, or compositions are not written about in detail. However, a skilled person can use these embodiments and/or examples in commerce without these specific details or their equivalents. Thus, the Detailed Description focuses on enabling the inventive elements of any ECIN. Where this Detailed Description refers to some elements in the singular tense, more than one element can be depicted in the Figures and like elements are labeled with like numerals.

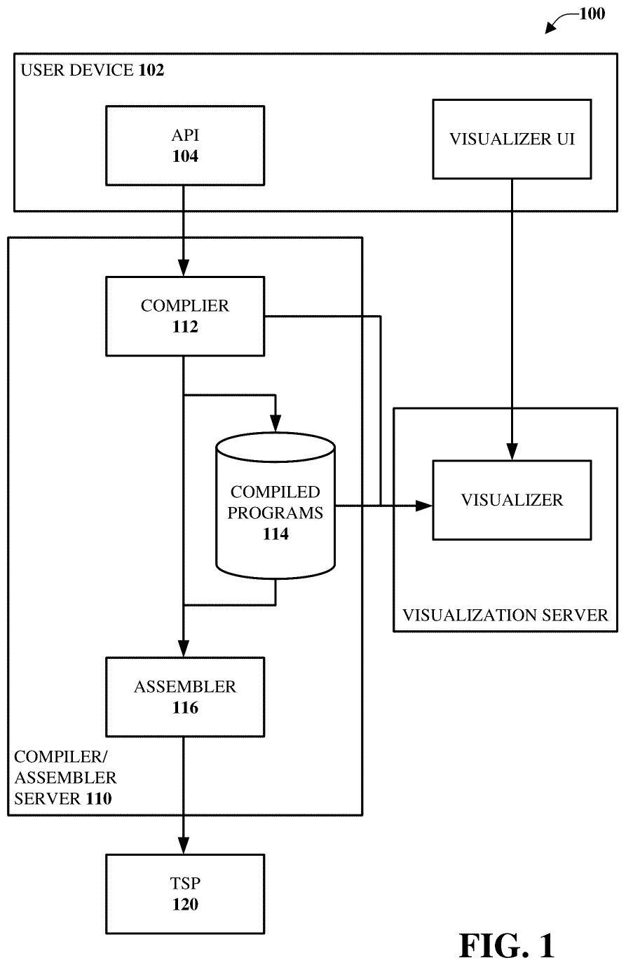

FIG. 1 illustrates a system 100 for compiling programs to be executed on a tensor processor, and for generating power usage information for the compiled programs, according to an embodiment. The system 100 includes a user device 102, a server 110, and a processor 120. Each of these components, and their sub-components (if any) are described in greater detail below. Although a particular configuration of components is described herein, in other embodiments the system 100 have different components and these components perform the functions of the system 100 in a different order or using a different mechanism. For example, while FIG. 1 illustrates a single server 110, in other embodiments, compilation, assembly, and power usage functions are performed on different devices. For example, in some embodiments, at least a portion of the functions performed by the server 110 are performed by the user device 102.

The user device 102 comprises any electronic computing device, such as a personal computer, laptop, or workstation, which uses an Application Program Interface (API) 104 to construct programs to be run on the processor 120. The server 110 receives a program specified by the user at the user device 102, and compiles the program to generate a compiled program 114. In some embodiments, a compiled program 114 enables a data model for predictions that processes input data and makes a prediction from the input data. Examples of predictions are category classifications made with a classifier, or predictions of time series values. In some embodiments, the prediction model describes a machine learning model that includes nodes, tensors, and weights. In one embodiment, the prediction model is specified as a TensorFlow model, the compiler 112 is a TensorFlow compiler and the processor 120 is a tensor processor (e.g., a tensor streaming processor TSP). In another embodiment, the prediction model is specified as a PyTorch model, the compiler is a PyTorch compiler. In other embodiments, other machine learning specification languages and compilers are used. For example, in some embodiments, the prediction model defines nodes representing operators (e.g., arithmetic operators, matrix transformation operators, Boolean operators, etc.), tensors representing operands (e.g., values that the operators modify, such as scalar values, vector values, and matrix values, which may be represented in integer or floating-point format), and weight values that are generated and stored in the model after training. In some embodiments, where the processor 120 is a tensor processor having a functional slice architecture, the compiler 112 generates an explicit plan for how the processor will execute the program, by translating the program into a set of operations that are executed by the processor 120, specifying when each instruction will be executed, which functional slices will perform the work, and which stream registers will hold the operands. This type of scheduling is known as “deterministic scheduling.” This explicit plan for execution includes information for explicit prediction of excessive power usage by the processor when executing the program.

The assembler 116 receives compiled programs 114, generated by the compiler 112, and performs final compilation and linking of the scheduled instructions to generate a compiled binary. In some embodiments, the assembler 114 maps the scheduled instructions indicated in the compiled program 112 to the hardware of the server 110, and then determines the exact component queue in which to place each instruction.

The processor 120, for example, is a hardware device with a massive number of matrix multiplier units that accepts a compiled binary assembled by the assembler 116, and executes the instructions included in the compiled binary. The processor 120 typically includes one or more blocks of circuity for matrix arithmetic, numerical conversion, vector computation, short-term memory, and data permutation/switching. One such processor 120 is a tensor processor having a functional slice architecture. In some embodiments, the processor 120 comprises multiple tensor processors connected together.

### Example Processor

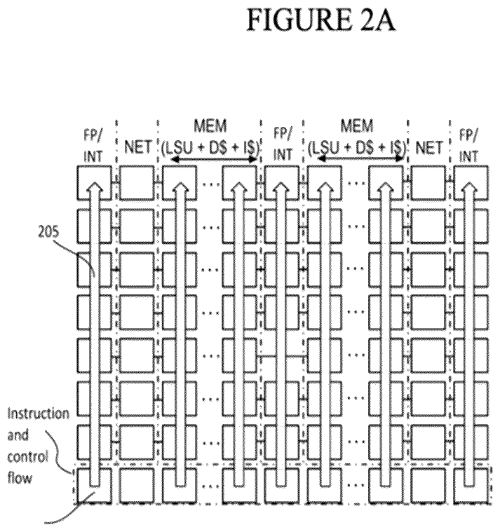

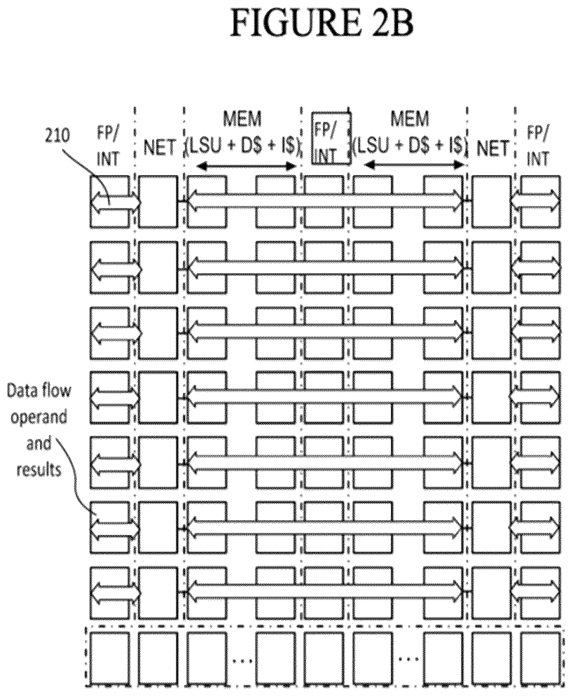

FIGS. 2A and 2B illustrate instruction and data flow in a processor having a functional slice architecture, in accordance with some embodiments. One enablement of processor 200 is as an application specific integrated circuit (ASIC), and corresponds to processor 120 illustrated in FIG. 1.

The functional units of processor 200 (also referred to as “functional tiles”) are aggregated into a plurality of functional process units (hereafter referred to as “slices”) 205, each corresponding to a particular function type in some embodiments. For example, different functional slices of the processor correspond to processing units for MEM (memory), VXM (vector execution module), MXM (matrix execution module), NIM (numerical interpretation module), and SXM (switching and permutation module). In other embodiments, each tile may include an aggregation of functional units such as a tile having both MEM and execution units by way of example. As illustrated in FIGS. 2A and 2B, each slice corresponds to a column of N functional units extending in a direction different (e.g., orthogonal) to the direction of the flow of data. The functional units of each slice can share an instruction queue (not shown) that stores instructions, and an instruction control unit (ICU) 210 that controls execution flow of the instructions. The instructions in a given instruction queue are executed only by functional units in the queue's associated slice and are not executed by another slice of the processor. In other embodiments, each functional unit has an associated ICU that controls the execution flow of the instructions.

Processor 200 also includes communication lanes to carry data between the functional units of different slices. Each communication lane connects to each of the slices 205 of processor 200. In some embodiments, a communication lane 220 that connects a row of functional units of adjacent slices is referred to as a “super-lane”, and comprises multiple data lanes, or “streams”, each configured to transport data values along a particular direction. For example, in some embodiments, each functional unit of processor 200 is connected to corresponding functional units on adjacent slices by a super-lane made up of multiple lanes. In other embodiments, processor 200 includes communication devices, such as a router, to carry data between adjacent functional units.

By arranging the functional units of processor 200 into different functional slices 205, the on-chip instruction and control flow of processor 200 is decoupled from the data flow. Since many types of data are acted upon by the same set of instructions, what is important for visualization is visualizing the flow of instructions, not the flow of data. For some embodiments, FIG. 2A illustrates the flow of instructions within the processor architecture, while FIG. 2B illustrates the flow of data within the processor architecture. As illustrated in FIGS. 2A and 2B, the instructions and control signals flow in a first direction across the functional units of processor 200 (e.g., along the length of the functional slices 205), while the data flows 220 flow in a second direction across the functional units of processor 200 (e.g., across the functional slices) that is non-parallel to the first direction, via the communication lanes (e.g., super-lanes) connecting the slices.

In some embodiments, the functional units in the same slice execute instructions in a ‘staggered’ fashion where instructions are issued tile-by-tile within the slice over a period of N cycles. For example, the ICU for a given slice may, during a first clock cycle, issue an instruction to a first tile of the slice (e.g., the bottom tile of the slice as illustrated in FIG. 2B, closest to the ICU of the slice), which is passed to subsequent functional units of the slice over subsequent cycles. That is, each row of functional units (corresponding to functional units along a particular super-lane) of processor 200 executes the same set of instructions, albeit offset in time, relative to the functional units of an adjacent row.

The functional slices of the processor are arranged such that operand data read from a memory slice is intercepted by different functional slices as the data moves across the chip, and results flow in the opposite direction where they are then written back to memory. For example, a first data flow from a first memory slice flows in a first direction (e.g., towards the right), where it is intercepted by a VXM slice that performs a vector operation on the received data. The data flow then continues to an MXM slice which performs a matrix operation on the received data. The processed data then flows in a second direction opposite from the first direction (e.g., towards the left), where it is again intercepted by VXM slice to perform an accumulate operation, and then written back to the memory slice.

In some embodiments, the functional slices of the processor are arranged such that data flow between memory and functional slices occur in both the first and second directions. For example, a second data flow originating from a second memory slice that travels in the second direction towards a second slice, where the data is intercepted and processed by VXM slice before traveling to the second MXM slice. The results of the matrix operation performed by the second MXM slice then flow in the first direction back towards the second memory slice.

In some embodiments, stream registers are located along a super-lane of the processor. The stream registers are located between functional slices of the processor to facilitate the transport of data (e.g., operands and results) along each super-lane. For example, within the memory region of the processor, stream registers are located between sets of four MEM units. The stream registers are architecturally visible to the compiler and serve as the primary hardware structure through which the compiler has visibility into the program's execution. Each functional unit of the set contains stream circuitry configured to allow the functional unit to read or write to the stream registers in either direction of the super-lane. In some embodiments, each stream register is implemented as a collection of registers, corresponding to each stream of the super-lane, and sized based upon the basic data type used by the processor (e.g., if the TSP's basic data type is an INT8, each register may be 8-bits wide). In some embodiments, in order to support larger operands (e.g., FP16 or INT32), multiple registers are collectively treated as one operand, where the operand is transmitted over multiple streams of the super-lane.

All of these functional features-superlanes of functional units, slices of instruction flow, handling of different types of integers and floating-point numbers, occurring trillions of times a second, create complicated power flows and possible disruptive power fluctuations that could negatively impact the performance of the processor. However, given the deterministic nature of executions by the processor, any disruptive power fluctuations (such as voltage droop) can be determined before execution of the program, with information (such as processor instructions, and timing for such instructions) about such fluctuations being supplied by the compiler to the processor, for the processor to use during program execution to mitigate the fluctuations.

### Detecting Attacks on Power Supplies by Comparing Shift Registers

In some of the embodiments disclosed herein, a dual tracking LFSR method is enabled to detect attacks on power supplies. This method ensures, with a high probability, after a chip is securely initialized after powerup that power disruption/glitch attacks are mitigated, by operating a Finite State Machine (FSM) to detect proper reset activation without the necessity for an analog IP module, and to provide a monitoring mechanism as a countermeasure to other power supply disruption security attacks.

The Dual-Tracking LFSR Method is an alternative digital logic approach designed to provide a more comprehensive and fundamental solution that overcomes limitations that exist, for example, with a simple register matching approach. A pair of Linear Feedback Shift Registers (LFSR) emit a measure and reference indicators that change constantly or continually (as a series of pseudo-random values separated by a large Hamming distance between consecutive values) to avoid the possibility of a data retention or data remanence failure with checks made during every clock period to detect potential power disruption events, and periodic anchor reference checks to mitigate against correlation failures. The assumption is that a security attack on the power supply will cause random disruptions in sub-circuits of the integrated circuit, such as the shift registers. After the security attack, the shift registers, initially set to the same values once during use of the integrated circuit, or reset periodically, will have different values from their initialized state. Comparing the two shift registers indicates that a security attack has occurred, and other sub-circuits of the integrated circuit can be triggered to mitigate the attack.

Note: all of the embodiments disclosed herein can use more than 2 shift registers. However, this does not significantly improve detection of attacks, and requires extra floorspace in the integrated circuit.

The Dual-Tracking LFSR state machine operates concurrently with the Boot FSM; it shares the same MasterReset signal and the same Chip Control Unit (CCU) Clock when DftBusEnable is False; anchor values are coordinated to occur at convenient clock counts; the Dual-Tracking LFSR FSM can also halt the Boot FSM when a fault is detected, but otherwise there is no interaction between the FSMs.

The variable DtlSize represents the number of bits in each register described below. The recommended value for DtlSize is 20. It is not a problem for the registers to roll over past their maximal count; in fact, that may be desirable because it allows the Anchor values to be used again with each cycle. The Dual-Tracking LFSR uses these subcircuits:
TrackingLFSR is a Linear Feedback Shift register with DtlSize bits
ReferenceLFSR is a Linear Feedback Shift register with DtlSize bits
DtlClockCounter is a binary counter with DtlSize bits
DtlLut is a lookup table that stores about DtlSize Anchor values of DtlSize bits each (e.g., equivalent to a 308 total of about 20*20=400 bits, likely synthesized as a network of logic gates)
TrackingCmp is a comparator between the TrackingLFSR and the ReferenceLFSR, using DtlSize 2-input XOR gates, all ORed together
AnchorCmp is a comparator between the Anchor DtlLut and the ReferenceLFSR, using DtlSize 2-input XOR gates, all ORed together
A glitch-free (smooth) multiplexor is used to switch the DtlClock source from the CCU clock to the DftScanClock based on the state of the DftBusEnable signal

When MasterReset is asserted, the DtlClockCounter is initialized, and the TrackingLFSR and the ReferenceLFSR are both set to a particular initial value. With DtlSize of 20, the initial value is 0x4ACDC and the polynomial is X20+X17+1 providing a maximal count duration of 220-1. The DtlClockCounter should be configured to also roll over after a duration of 220-1 (going directly from count 0xFFFFE to 0x00000, skipping the count value of 0xFFFFF).

AnchorDecode is the signal which indicates when the value of DtlClockCounter is a valid location for a stored Anchor value in DtlLut. A strategy for selecting which DtlClockCounter values to use as an index to the Anchor values in the DtlLut is:
One Anchor value just prior to the decision to activate DFT mode or not.
One Anchor value just prior to the handoff to mutable FW. Because the number of Boot FSM clock cycles depends on several factors including the variable Firm Ware (FW) size, it is acceptable to designate one or more targeted Anchor values using a best effort strategy—e.g., pick a cycle count that is the smallest cycle count that is prior to the event, or the average, or most likely.

One Anchor value for each of the logarithmically distributed count values of DtlClockCounter (the equivalent to where exactly one bit from bit2 through bit 19 has the value one, and all other DtlClockCounter bits are zero, assuming the DtlClockCounter was initialized to zero, or the equivalent logarithmic separation if the DtlClockCounter is initialized to a non-zero value).

The layout of the two LFSRs should be carefully arranged during IC physical design to avoid any possible bias in the direction of the special initialization value. Specifically, there is no difference on the Set or Clr inputs for One or Zero values, and no systematic difference in the intentionally different physical layout of the two LFSRs, so that whatever subtle influence that they might have on the initial values that they naturally power up as, they should be different. Similarly, to avoid exposure to instances of power-up values of all-zeros or all-ones, the DtlClockCounter should be implemented with an initialization value such as 0x98765 with a mix of DFF bits such that about half of the bits are initialized to logic one, and the remainder are initialized to logic zero, and where the logic one initialized bits have their Q output inverted in normal usage, with the rollover mechanism configured accordingly.

The TrackingLFSR and the ReferenceLFSR will both be initialized to the 0x4ACDC pattern by the MasterReset signal, where each register bit is assigned to be either a LogicOneBit or a LogicZeroBit according to the selected pattern. Every register bit must be implemented during PD using the same identical DFF cell to avoid any initialization bias. The chosen DFF cell has an asynchronous Set input and an asynchronous Clr input. The asynchronous control inputs of the DFF register bits are configured as follows:

| | |
|---|---|
| LogicOneBits: DffSet = SetAll \|\| MasterReset; | DffClr = ClrAll |
| LogicZeroBits: DffSet = SetAll; | DffClr = ClrAll \|\| |

MasterReset

All three 20-bit registers (e.g., the TrackingLFSR, ReferenceLFSR, and DtlClockCounter) are asynchronously initialized by the MasterReset signal, with careful attention to the recovery/removal timing constraints for the asynchronous control inputs to ensure robust behavior during the first few clock cycles after reset has been deasserted.

The DFF cell must not have a Qbar output, and the Q output must be connected directly and only to a buffer cell (two inverters in series) that is the exact same buffer cell for every register bit to minimize any differential loading effects that could bias the initialization values. The buffer outputs are synthesized into the logic comparator network that detects correspondence of the ReferenceLFSR with the TrackingLFSR, the Anchor values, or the all-zero pattern.

The DTL block protects the chip from power glitch attacks during normal scan test operation, so it cannot itself be scan tested using the normal scan method applicable to the remainder of the chip. Two alternative ways to test this block are documented below, one of which is the dedicated scan mode. In any case, the launch mechanism must be compatible with all aspects of the operation of the DTL block.

1. Design an independent DtlScan structure for only this block, with dedicated DtlScanIn and DtlScanOut pins; the DFT Scan Clock can be reused for DtlScan. It is possible to share the DtlScanIn with a normal ScanIn pin as long as the non-DtlScan signal path is properly blocked as specified; the same applies for DtlScanOut/ScanOut. The DtlScan test is necessary to qualify the part (this is not a normal scan test); it should be launched separately from the normal DFT scan test, typically after other DFT scan tests are complete

2. Use LBIST techniques as DtlLBIST to test this block. If DtlLBIST is used, then the quality of the test coverage could be graded by performing fault simulation on the DTL block, observing only the DtlMISR output pin, to compute the fault coverage of the LBIST operation. The LFSR DFF cells are generally connected in a D-Q shift register, which may advantageously be used as one or more LBIST scan chains, where the inputs are driven by the LBIST PRPG and the outputs drive the LBIST MISR. In particular, it may be advantageous to use one of the LFSRs as the LBIST PRPG, and to use the other LFSR as the LBIST MISR. In this configuration, a large portion of the Dual-Tracking LFSR FSM may be used as an LBIST controller to test itself. The buffered Q outputs of the PRPG may propagate through intermediate observation nodes connected to LBIST MISR inputs. At LBIST completion, the MISR output is shifted out on a GPIO pin. The SetAll and ClrAll signals are emitted by the LBIST controller (of course they should not both be active at the same time) as part of the test sequence before the pseudorandom patterns are generated, and should not be pruned during synthesis to avoid having constants propagated to the LFSR DFF asynchronous inputs which might otherwise bias the power-up initial values. The ReferenceLFSR pattern must match the TrackingLFSR at every rising edge of the CcuClock when DftBusEnable is False, and at every rising edge of the DFT Scan Clock when DftBusEnable is True, up until the final test is launched. A necessary functional test to qualify the part (this is not a normal scan test) is to launch an LBIST test of the Dual-Tracking LFSR circuitry; the LBIST result is shifted out on a dedicated GPIO output pin called DtlMISR. Note that launching the LBIST test implicitly deactivates all other JTAG and DFT ScanIn and ScanOut pins because the ReferenceLFSR will no longer match the TrackingLFSR values.

Normally the all-zero state of an LFSR is prohibited, and the LFSR is forced into some non-zero next state to avoid deadlock. Further, the all-zero state is a very plausible initial state for the uninitialized LFSR to arrive at after power up. Both of these properties can be conveniently exploited whereby the implementation intentionally does not exit out of the all-zeros state; in an embodiment, the LFSRs are intentionally allowed to remain locked in the all-zero state. The all-zero state is directly detected as an immediate fault condition.

Whenever any mismatch is detected between the ReferenceLFSR and the TrackingLFSR, or between the ReferenceLFSR and the Anchor values on selected DtlClockCounter values, or when an all-zero value is detected on the ReferenceLFSR, the signal DtlMismatch will be set True, and will stay True until MasterReset is asserted. The logical expression is DtlMismatch=DtlMismatch∥(ReferenceLFSR!=TrackingLFSR)∥((ReferenceLFSR!=DtlLut [DtlClockCounter]) && AnchorDecode[DtlClockCounter])∥(ReferenceLFSR==0). DtlMismatch is asynchronously reset when MasterReset is asserted. In order to satisfy timing constraints for logic networks and signal distribution related to the DtlMismatch signal, it is acceptable to insert a limited number of pipeline registers clocked by DtlClock. When DtlMismatch is True, the following actions will be taken:

1. DftBusEnable is forced to be False, terminating DFT access.

2. If the Boot FSM is still underway, a set of General Purpose Input Output (GPIO) pins will be asserted to indicate the fault condition, a Configuration Status Register (CSR) GlobalFault (GFault) flag named “DtlBootFail” will be set, and the Boot FSM will HALT.

3. If FW is running, a uP interrupt will be set and the FW is responsible for executing a mitigation response, or possibly on other chips a set of GPIO pins will be asserted to indicate the fault condition, a CSR GFault flag named “DtlFwFail” will be set, and the TSP will HALT.

Any mechanism to deactivate Dual-Tracking LFSR protection using Efuse bits or GPIO pins would degrade the security benefits provided by this method. A FIB Microsurgery Link should be implemented so that the inverse of this signal (e.g., NotDtlMismatch) can be overridden in extreme conditions.

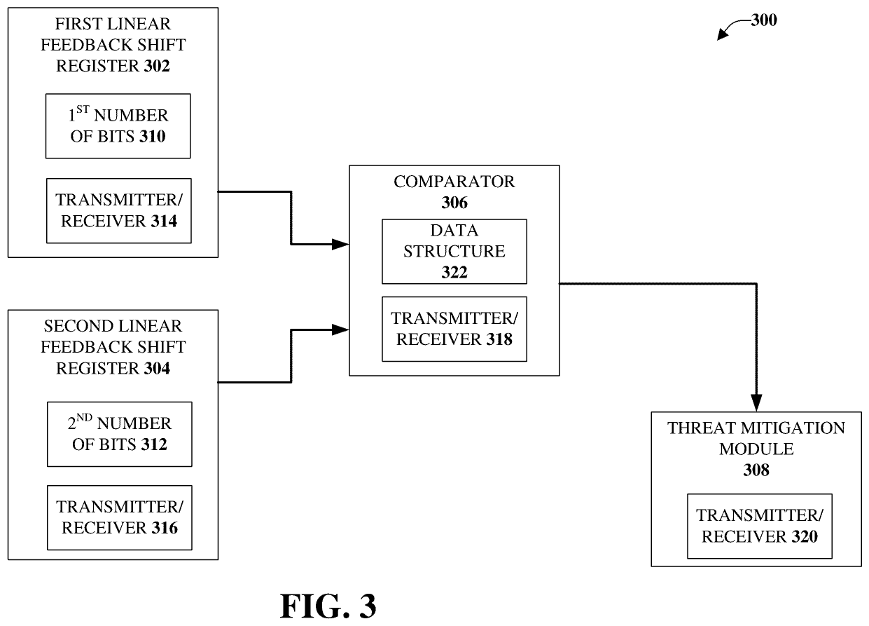

FIG. 3 illustrates a system 300 that facilitates detection of attacks on power supplies according to one or more embodiments described herein. The system 300 includes two Linear Feedback Shift Registers (two LFSRs), illustrated as a first LFSR 302 and a second LFSR 304. Also included in the system 300 is a comparator 306 and a threat mitigation module 308.

The first LFSR has a first number of bits 310 and the second LFSR has a second number of bits 312. The first number of bits 310 and the second number of bits 312 can be a same number of bits or can be a different number of bits. For purposes of threat mitigation as discussed herein, the first number of bits 310 and the second number of bits 312 are the same number of bits (e.g., are an equal size number of bits). In an example, the first number of bits 310 and the second number of bits 312 is equal to 20 bits. However, in some implementations, more than 20 bits, or less than 20 bits are utilized. It is noted that, at each clock cycle, the first number of bits 310 and the second number of bits 312 can respectively change values.

The two LFSRs (the first LFSR 302 and the second LFSR 304) can be initialized at power up. Alternatively, or additionally, the two LFSRs can be reset to an initial condition. In an example, the first LFSR 302 is a tracking LFSR and the second LFSR 304 is a reference LFSR. Alternatively, the first LFSR 302 is a reference LFSR and the second LFSR 304 is a tracking LFSR.

As illustrated, the first LFSR 302 includes a transmitter/receiver component 314 and the second LFSR 304 includes a transmitter/receiver component 316. Via the transmitter/receiver component 314, the first LFSR 302 emits one or more first signals. The one or more first signals can include measure and reference indicators that change constantly, continually, frequently, or periodically. For example, the one or more first signals can be emitted (via the transmitter/receiver component 314) as a series of pseudo-random values separated by a large Hamming distance between consecutive values. The one or more first signals can comprise information indicative of the first number of bits 310.

In a similar manner, via the transmitter/receiver component 316, second LFSR 304 emits one or more second signals. The one or more second signals can include measure and reference indicators that change often. For example, the one or more second signals can be emitted (via the transmitter/receiver component 316) as a series of pseudo-random values separated by a large Hamming distance between consecutive values. The one or more second signals can comprise information indicative of the second number of bits 312.

The one or more first signals and the one or more second signals can be received at the comparator 306 via a transmitter/receiver component 318. Accordingly, during each clock cycle, the comparator 306 can evaluate the values of the two LFSRs (e.g., the first number of bits 310, the second number of bits 312). For example, the comparator 306 compares the first value of the first number of bits 310 to the second value of the second number of bits 312. If the first value and the second value are the same value (e.g., match), no action is taken and, during a next clock cycle, the comparator 306 performs another comparison.

Alternatively, if the comparator 306 determines that the first value and the second value are different values, an error is reported by the comparator 306 (via the transmitter/receiver component 318) to the threat mitigation module 308 (via a transmitter/receiver component 320). Based at least in part on the reported error, the threat mitigation component can initiate and perform threat mitigation as discussed herein.

According to some implementations, the comparator 306 can include a data structure 322 that can store information indicative of anchor values and the number of bits in the LFSRs (e.g., the first number of bits 310, the second number of bits 312). In an example, the data structure 322 can be a lookup table. The anchor values can be coordinated to occur at convenient clock counts. Further, the anchor values can be used repeatedly at each clock cycle.

In an implementation, the two LFSRs (e.g., the first LFSR 302, the second LFSR 304) can include respective groups of register bits. For example, the first LFSR 302 can include a first group of register bits and the second LFSR 304 can include a second group of register bits. Further, register bits of the respective groups of register bits is assigned to a defined value according to a selected pattern. In an example, the defined value is a LogicOneBit or a LogicZeroBit.

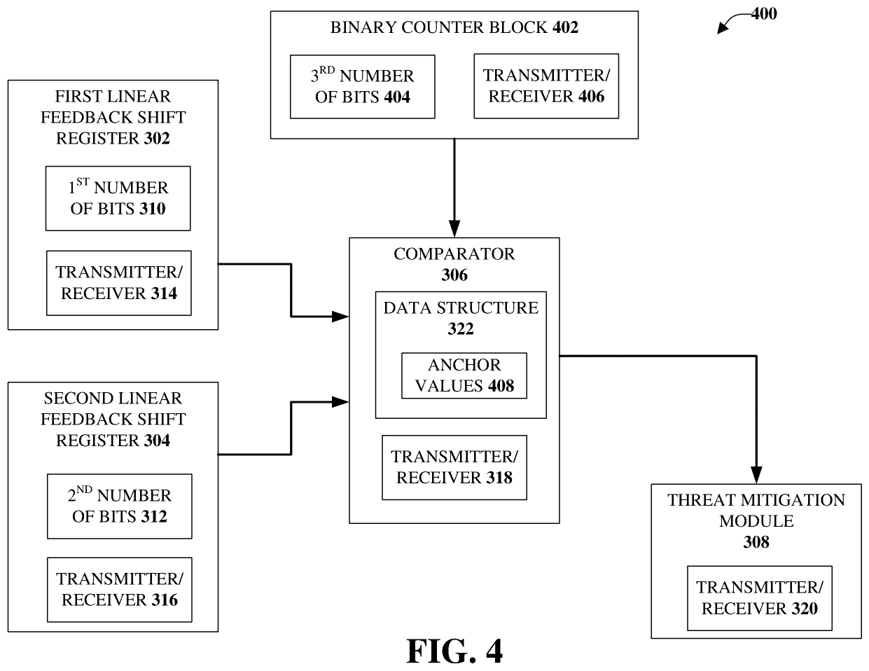

FIG. 4 illustrates another system 400 that facilitates threat mitigation for integrated circuits according to one or more embodiments described herein. Repetitive description of like elements employed in other embodiments described herein is omitted for sake of brevity.

As illustrated, the system 400 includes the first LFSR 302 (also referred to as a first LFSR block), the second LFSR 304 (also referred to as a second LFSR block), and a binary counter block 402. It is noted that, according to some implementations, only one LFSR is included in the system 400.

The binary counter block 402 includes a third set of bits 404. According to some implementations, the first number of bits 310 (of the first LFSR 302), the second number of bits 312 (of the second LFSR 304), and the third number of bits 404 (of the binary counter block 402) are the same number of bits (e.g., have an equal size in a number of bits). In an example, the first number of bits 310, the second number of bits 312, and the third number of bits 404 is equal to 20 bits. However, in some implementations, more than 20 bits, or less than 20 bits are utilized. It is noted that, at each clock cycle, the first number of bits 310, the second number of bits 312, and the third number of bits 404 can respectively change values. The binary counter block 402 can include a transmitter/receiver component 406 that can communicate information indicative of the third number of bits 404.

The two LFSRs (the first LFSR 302 and the second LFSR 304) and the binary counter block 402 can be initialized at power up. Alternatively, or additionally, the two LFSRs and the binary counter block 402 can be reset to an initial condition.

Similar to the system 300 of FIG. 3, the first LFSR 302 emits one or more first signals and the second LFSR 304 emits one or more second signals. The one or more first signals and the one or more second signals can be received at the comparator 306 via a transmitter/receiver component 318. Accordingly, during each clock cycle, the comparator 306 can evaluate the values of the two LFSRs (e.g., the first number of bits 310, the second number of bits 312). For example, the comparator 306 compares the first value of the first number of bits 310 to the second value of the second number of bits 312. If the first value and the second value are the same value (e.g., match), no action is taken and, during a next clock cycle, the comparator 306 performs another comparison.

Alternatively, if the comparator 306 determines that the first value and the second value are different values, an error is reported by the comparator 306 (via the transmitter/receiver component 318) to the threat mitigation module 308 (via a transmitter/receiver component 320). Based at least in part on the reported error, the threat mitigation component can initiate and perform threat mitigation as discussed herein.

Additionally, the data structure 322 can include anchor values 408, as described above. The anchor values 408 can include anchor times and expected values. For example, the anchor times can specify defined times after initialization and/or reset to an initial condition. Further, the expected values can be respective expected values that correspond to the defined anchor times.

Thus, during each anchor time, the first value of the first number of bits 310 or the second value of the second number of bits 312 is compared, by the comparator 306, to the respective expected anchor value. If the values match (e.g., the first number of bits 310 matches the expected anchor value, the second number of bits 312 matches the expected anchor value), no action is taken and, during a next anchor time, the comparator 306 performs another comparison.

Alternatively, if the comparator 306 determines that the values are different values (e.g., the first number of bits 310 fails to match the expected anchor value, the second number of bits 312 fails to match the expected anchor value), an error is reported by the comparator 306 (via the transmitter/receiver component 318) to the threat mitigation module 308 (via a transmitter/receiver component 320). Based at least in part on the reported error, the threat mitigation component can initiate and perform threat mitigation as discussed herein.

Although FIG. 4 has been described with respect to two LFSRs, according to some implementations, only one LFSR (e.g., the first LFSR 302) is utilized in conjunction with the binary counter block 402. In this implementation, the first number of bits 310 of the first LFSR 302 and the third number of bits 404 of the binary counter block 402 are emitted to the comparator 306. The first LFSR 302 and the binary counter block 402 are initialized at power up, or reset to an initial condition. Further to these implementations, during each anchor time listened in the table of anchor times and expected values (e.g., anchor values 408), the first number of bits 310 is compared to the expected value (at the particular anchor time). If the values are the same, no action is taken and, during a next clock cycle, the comparator 306 performs another comparison.

Alternatively, if the comparator 306 determines that the first number of bits 310 and the anchor value are different values, an error is reported by the comparator 306 (via the transmitter/receiver component 318) to the threat mitigation module 308 (via a transmitter/receiver component 320). Based at least in part on the reported error, the threat mitigation component can initiate and perform threat mitigation as discussed herein.

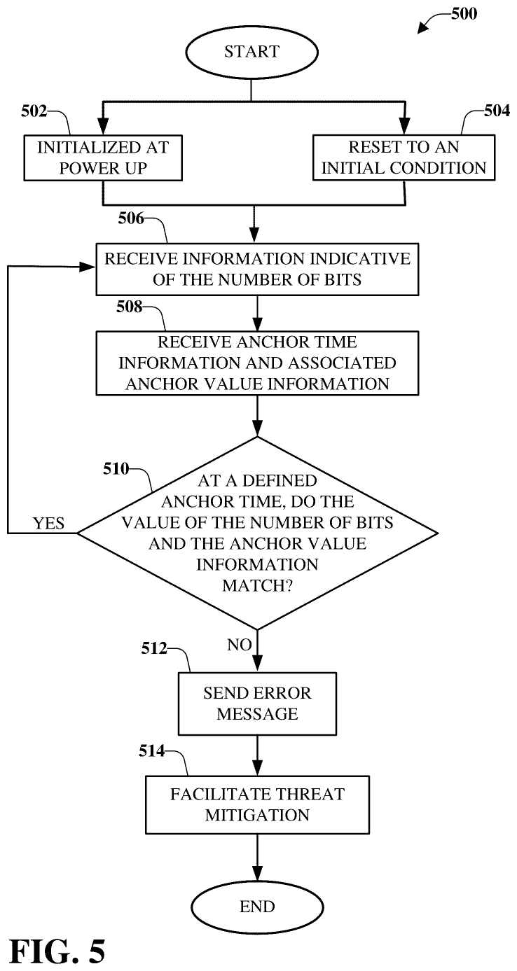

FIG. 5 illustrates a computer-implemented method 500 that facilitates threat mitigation using anchor times according to one or more embodiments described herein. The computer-implemented method 500 can be implemented by the system 300 of FIG. 3 and/or the system 400 of FIG. 4. Repetitive description of like elements employed in other embodiments described herein is omitted for sake of brevity.

The computer-implemented method 500 begins, at 502, when at least one linear feedback shift register (LFSR) and one binary counter are initialized at power up, or at 504, when the at least one LFSR and the one binary counter are reset to an initial condition. The at least one LFSR and the one binary counter can have a same number of bits.

Information indicative of the value of a number of bits can be received, at 506, such as at a comparator (e.g., the comparator 306). The value of the number of bits can be the number of bits for the at least one LFSR. Further, at 508, anchor time information and associated anchor value information can be received. It is noted that the receipt of information at 506 and the receipt of information at 508 can be performed at the same time, at substantially the same time, or at different times.

At a defined anchor time, a determination is made, at 510, whether the value of the number of bits and the anchor value information are the same (e.g., match). If the values match (“YES”), the computer-implemented method 500 returns to 506 and subsequent information indicative of the value of a number of bits can be received, and at 508 subsequent anchor time information and associated anchor value information can be received.

Alternatively, if the determination at 510 is that the values do not match (“NO”), at 512, the computer-implemented method 500 communicates an error message. Based on the error message, at 514, threat mitigation can be initiated and performed.

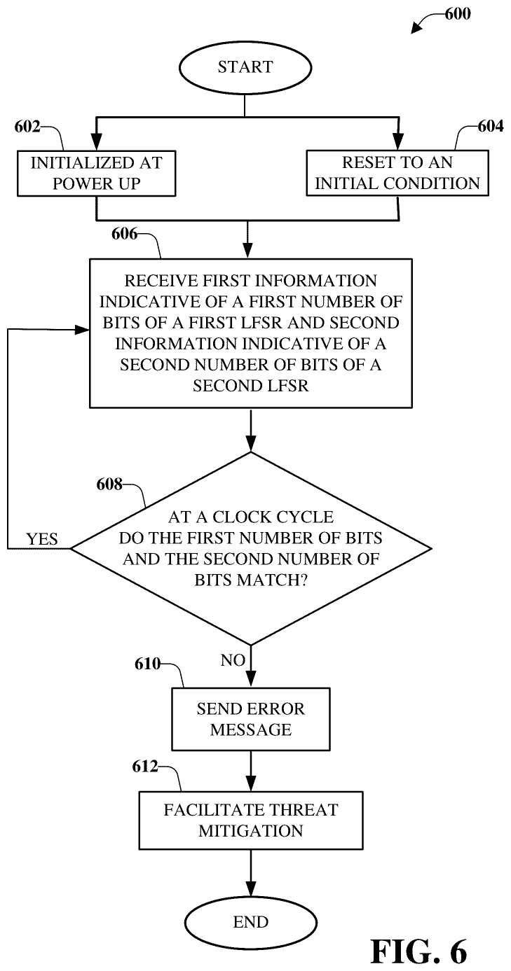

FIG. 6 illustrates a computer-implemented method 600 that facilitates threat mitigation using clock cycles according to one or more embodiments described herein. The computer-implemented method 600 can be implemented by the system 300 of FIG. 3 and/or the system 400 of FIG. 4. Repetitive description of like elements employed in other embodiments described herein is omitted for sake of brevity.

The computer-implemented method 600 begins, at 602, when two linear feedback shift registers (LFSRs) are initialized at power up, or at 604, when the two LFSRs are reset to an initial condition. The two LFSRs can include a first LFSR and a second LFSR. A first number of bits of the first LFSR and a second number of bits of the second LFSR can be a same number of bits.

Information indicative of the value of a number of bits for each LFSR can be received, at 506, such as at a comparator (e.g., the comparator 306). For example, first information indicative of the first number of bits of the first LFSR and second information indicative of the second number of bits of the second LFSR can be received.

At a clock cycle, a determination is made, at 608, whether the value of the first number of bits and the value of the second number of bits are the same (e.g., match). If the values match (“YES”), the computer-implemented method 600 returns to 606 and subsequent first information indicative of the first number of bits of the first LFSR and subsequent second information indicative of the second number of bits of the second LFSR can be received.

Alternatively, if the determination at 608 is that the values do not match (“NO”), at 610, the computer-implemented method 600 communicates an error message. Based on the error message, at 612, threat mitigation can be initiated and performed.

It is noted that, according to some implementations, the computer-implemented method 500 of FIG. 5 and the computer-implemented method 600 of FIG. 6 can be combined. Thus, at each clock cycle, the respective bit values of the LFSRs can be compared. Additionally, at each anchor time, the value of either LFSR (e.g., only one LFSR) can be compared to the anchor value. If either of the comparisons do not match, threat mitigation can be performed.

In an embodiment, a system includes two Linear Feedback Shift Registers (two LFSRs) of an equal size in a number of bits. For example, a first LFSR has a first number of bits and a second LFSR has a second number of bits. The first number of bits and the second number of bits is a same number of bits. However, in some embodiments, the first number of bits and the second number of bits can be a different number of bits. The two LFSRs can be initialized at power up. Alternatively, or additionally, the two LFSRs can be reset to an initial condition. In an example, the first LFSR is a tracking LFSR and the second LFSR is a reference LFSR. In another example, the respective number of bits in each LFSRs is 20 bits. During each clock cycle, the values of the two LFSRs are compared to each other. For example, a first value of the first LFSR is compared to a second value of the second LFSR. If the first value and the second value are the same value (e.g., match), no action is taken. Alternatively, if the first value and the second value are different values, an error is reported and threat mitigation initiated.

The two LFSRs can emit respective measure and reference indicators that change continually or at another time frequency. For example, the first LFSR emits first measure and reference indicators and the second LFSR emits second measure and reference indicators. The respective measure and reference indicators can be emitted as a series of pseudo-random values separated by a large Hamming distance between consecutive values.

According to an implementation, the system can include a binary counter comprising a same number of bits as the two LFSRs. In another embodiment, the system can include a lookup table that stores information indicative of anchor values and the number of bits in the two LFSRs. The anchor values can be coordinated to occur at convenient clock counts.

In an implementation, the two LFSRs can include respective groups of register bits. For example, the first LFSR can include a first group of register bits and the second LFSR can include a second group of register bits. Further, register bits of the respective groups of register bits is assigned to a defined value according to a selected pattern. In an example, the defined value is a LogicOneBit or a LogicZeroBit.

Another embodiment relates to a system that includes one Linear Feedback Shift Register (LFSR) and one binary counter of an equal size in a number of bits. For example, the LFSR has a first size (e.g., a first number of bits) and the binary counter has a second size (e.g., a second number of bits). In an example, the first size and the second size are a same size (e.g., the first number of bits and the second number of bits are an equal number of bits).

Further, the LFSR and the binary power can be initialized at power up or reset to an initial condition. During each anchor time listed in a table of anchor times and expected values, the values of the LFSR is compared to an expected value from the list. If there is a mismatch between the value of the LFSR and the expected value from the list, an error is reported and threat mitigation initiated.

In an example, the anchor times are coordinated to occur at defined clock counts. According to another example, the system operates concurrently with a boot Finite State Machine (FSM). Based on the mismatch, operation of the boot FSM is halted. Further, in some examples, the LFSR is a tracking LFSR. In other examples, the LFSR is a reference LFSR.

Another embodiment relates to a system that includes two Linear Feedback Shift Register (LFSR) blocks and one binary counter block. All three blocks (e.g., the two LFSR blocks and the one binary counter block) have an equal size in a number of bits. For example, a first size (first number of bits) of a first LFSR, a second size (second number of bits) of a second LFSR, and a third size (third number of bits) of the binary counter block are the same size (e.g., same number of bits). The two LFSRs and the binary counter block are initialized at power up or reset to an initial condition. The values of the two LFSRs are compared during each clock cycle. If the comparison indicates that the values do not match (e.g., there is a mismatch), an error is reported and threat mitigation initiated. Further, during each anchor time listed in a table of anchor times and expected values, the value of either LFSR is compared to an expected value from the list, and if there is a mismatch, the error is reported and threat mitigation initiated.

In an example, two LFSRs emit respective measure and reference indicators that change constantly or at another frequency. The respective measure and reference indicators are emitted as a series of pseudo-random values separated by a large Hamming distance between consecutive values. In another example, a first LFSR of the two LFSRs is a tracking LFSR, and a second LFSR of the two LFSRs is a reference LFSR. In yet another example, the two LFSRs comprise respective groups of register bits. Further, register bits of the respective groups of register bits is assigned to a defined value according to a selected pattern.

### DETAILED DESCRIPTION—TECHNOLOGY SUPPORT FROM DATA/INSTRUCTIONS TO PROCESSORS/PROGRAMS

Data and Information. While ‘data’ and ‘information’ often are used interchangeably (e.g., ‘data processing’ and ‘information processing’), the term ‘datum’ (plural ‘data’) typically signifies a representation of the value of a fact (e.g., the measurement of a physical quantity such as the current in a wire, or the price of gold), or the answer to a question (e.g., “yes” or “no”), while the term ‘information’ typically signifies a set of data with structure (often signified by ‘data structure’). A data structure is used in commerce to transform an electronic device for use as a specific machine as an article of manufacture (see In re Lowry, 32 F.3d 1559 [CAFC, 1994]). Data and information are physical objects, for example binary data (a ‘bit,’ usually signified with ‘0’ and ‘1’) enabled with two levels of voltage in a digital circuit or electronic component. For example, data can be enabled as an electrical, magnetic, optical, or acoustical signal or state; a quantum state such as a particle spin that enables a ‘qubit;’ or a physical state of an atom or molecule. All such data and information, when enabled, are stored, accessed, transferred, combined, compared, or otherwise acted upon, actions that require and dissipate energy.

As used herein, the term ‘process’ signifies an artificial finite ordered set of physical actions (‘action’ also signified by ‘operation’ or ‘step’) to produce at least one result. Some types of actions include transformation and transportation. An action is a technical application of one or more natural laws of science or artificial laws of technology. An action often changes the physical state of a machine, of structures of data and information, or of a composition of matter. Two or more actions can occur at about the same time, or one action can occur before or after another action, if the process produces the same result. A description of the physical actions and/or transformations that comprise a process are often signified with a set of gerund phrases (or their semantic equivalents) that are typically preceded with the signifier ‘the steps of’ (e.g., “a process comprising the steps of measuring, transforming, partitioning and then distributing . . . ”). The signifiers ‘algorithm,’ ‘method,’ ‘procedure,’ ‘(sub) routine,’ ‘protocol,’ ‘recipe,’ and ‘technique’ often are used interchangeably with ‘process,’ and 35 U.S.C. 100 defines a “method” as one type of process that is, by statutory law, always patentable under 35 U.S.C. 101. As used herein, the term ‘thread’ signifies a subset of an entire process. A process can be partitioned into multiple threads that can be used at or about at the same time (e.g., at a same time, at substantially a same time).

As used herein, the term ‘rule’ signifies a process with at least one logical test (signified, e.g., by ‘IF test IS TRUE THEN DO process’). As used herein, a ‘grammar’ is a set of rules for determining the structure of information. Many forms of knowledge, learning, skills, and styles are authored, structured, and enabled—objectively—as processes and/or rules—e.g., knowledge and learning as functions in knowledge programming languages.

As used herein, the term ‘component’ (also signified by ‘part,’ and typically signified by ‘element’ when described in a patent text or diagram) signifies a physical object that is used to enable a process in combination with other components. For example, electronic components are used in processes that affect the physical state of one or more electromagnetic or quantum particles/waves (e.g., electrons, photons) or quasiparticles (e.g., electron holes, phonons, magnetic domains) and their associated fields or signals. Electronic components have at least two connection points which are attached to conductive components, typically a conductive wire or line, or an optical fiber, with one conductive component end attached to the component and the other end attached to another component, typically as part of a circuit with current or photon flows. There are at least three types of electrical components: passive, active and electromechanical. Passive electronic components typically do not introduce energy into a circuit-such components include resistors, memristors, capacitors, magnetic inductors, crystals, Josephson junctions, transducers, sensors, antennas, waveguides, etc. Active electronic components require a source of energy and can inject energy into a circuit-such components include semiconductors (e.g., diodes, transistors, optoelectronic devices), vacuum tubes, batteries, power supplies, displays (e.g., LEDs, LCDs, lamps, CRTs, plasma displays). Electromechanical components affect current flow using mechanical forces and structures-such components include switches, relays, protection devices (e.g., fuses, circuit breakers), heat sinks, fans, cables, wires, terminals, connectors, and printed circuit boards.

One of the most important components as goods in commerce is the integrated circuit, and its res of abstractions. As used herein, the term ‘integrated circuit’ signifies a set of connected electronic components on a small substrate (thus the use of the signifier ‘chip’) of semiconductor material, such as silicon or gallium arsenide, with components fabricated on one or more layers. Other signifiers for ‘integrated circuit’ include ‘monolithic integrated circuit,’ ‘IC,’ ‘chip,’ ‘microchip’ and ‘System on Chip’ (‘SoC’). Examples of types of integrated circuits include gate/logic arrays, processors, memories, interface chips, power controllers, and operational amplifiers. The term ‘cell’ as used in electronic circuit design signifies a specification of one or more components, for example, a set of transistors that are connected to function as a logic gate. Cells are usually stored in a database, to be accessed by circuit designers and design processes.

As used herein, the term ‘module’ signifies a tangible structure for acting on data and information. For example, the term ‘module’ can signify a process that transforms data and information, for example, a process comprising a computer program (defined below). The term ‘module’ also can signify one or more interconnected electronic components, such as digital logic devices. A process comprising a module, if specified in a programming language (defined below), such as System C or Verilog, also can be transformed into a specification for a structure of electronic components that transform data and information that produce the same result as the process. This last sentence follows from a modified Church-Turing thesis, which is simply expressed as “Whatever can be transformed by a (patentable) process and a processor, can be transformed by a (patentable) equivalent set of modules,” as opposed to the doublethink of deleting only one of the “(patentable).”

A module is permanently structured (e.g., circuits with unalterable connections), temporarily structured (e.g., circuits or processes that are alterable with sets of data), or a combination of the two forms of structuring. Permanently structured modules can be manufactured, for example, using Application Specific Integrated Circuits (‘ASICs’) such as Arithmetic Logic Units (‘ALUs’), Programmable Logic Arrays (‘PLAs’), or Read Only Memories (‘ROMs’), all of which are typically structured during manufacturing. For example, a permanently structured module can comprise an integrated circuit. Temporarily structured modules can be manufactured, for example, using Field Programmable Gate Arrays (FPGAs—for example, sold by Xilink or Intel's Altera), Random Access Memories (RAMs) or microprocessors. For example, data and information is transformed using data as an address in RAM or ROM memory that stores output data and information. One can embed temporarily structured modules in permanently structured modules (for example, a FPGA embedded into an ASIC).

Modules that are temporarily structured can be structured during multiple time periods. For example, a processor comprising one or more modules has its modules first structured by a manufacturer at a factory and then further structured by a user when used in commerce. The processor can comprise a set of one or more modules during a first time period, and then be restructured to comprise a different set of one or modules during a second time period. The decision to manufacture or implement a module in a permanently structured form, in a temporarily structured form, or in a combination of the two forms, depends on issues of commerce such as cost, time considerations, resource constraints, tariffs, maintenance needs, national intellectual property laws, and/or specific design goals [FACT]. How a module is used, its function, is mostly independent of the physical form in which it is manufactured or enabled. This last sentence also follows from the modified Church-Turing thesis.

As used herein, the term ‘processor’ signifies a tangible data and information processing machine for use in commerce that physically transforms, transfers, and/or transmits data and information, using at least one process. A processor consists of one or more modules, e.g., a central processing unit (‘CPU’) module; an input/output (‘I/O’) module, a memory control module, a network control module, and/or other modules. The term ‘processor’ can also signify one or more processors, or one or more processors with multiple computational cores/CPUs, specialized processors (for example, graphics processors or signal processors), and their combinations. Where two or more processors interact, one or more of the processors can be remotely located relative to the position of the other processors. Where the term ‘processor’ is used in another context, such as a ‘chemical processor,’ it will be signified and defined in that context.

The processor can comprise, for example, digital logic circuitry (for example, a binary logic gate), and/or analog circuitry (for example, an operational amplifier). The processor also can use optical signal processing, DNA transformations, quantum operations, microfluidic logic processing, or a combination of technologies, such as an optoelectronic processor. For data and information structured with binary data, any processor that can transform data and information using the AND, OR and NOT logical operations (and their derivatives, such as the NAND, NOR, and XOR operations) also can transform data and information using any function of Boolean logic. A processor such as an analog processor, such as an artificial neural network, also can transform data and information. No scientific evidence exists that any of these technological processors are processing, storing, and retrieving data and information, using any process or structure equivalent to the bioelectric structures and processes of the human brain.

The one or more processors also can use a process in a ‘cloud computing’ or ‘timesharing’ environment, where time and resources of multiple remote computers are shared by multiple users or processors communicating with the computers. For example, a group of processors can use at least one process available at a distributed or remote system, these processors using a communications network (e.g., the Internet, or an Ethernet) and using one or more specified network interfaces (‘interface’ defined below) (e.g., an application program interface (‘API’) that signifies functions and data structures to communicate with the remote process).

As used herein, the term ‘computer’ and ‘computer system’ (further defined below) includes at least one processor that, for example, performs operations on data and information such as (but not limited to) the Boolean logical operations using electronic gates that can comprise transistors, with the addition of memory (for example, memory structured with flip-flops using the NOT-AND or NOT-OR operation). Any processor that can perform the logical AND, OR and NOT operations (or their equivalent) is Turing-complete and computationally universal [FACT]. A computer can comprise a simple structure, for example, comprising an I/O module, a CPU module, and a memory that performs, for example, the process of inputting a signal, transforming the signal, and outputting the signal with no human intervention.

As used herein, the term ‘programming language’ signifies a structured grammar for specifying sets of operations and data for use by modules, processors, and computers. Programming languages include assembler instructions, instruction-set-architecture instructions, machine instructions, machine dependent instructions, microcode, firmware instructions, state-setting data, or either source code or object code written in any combination of one or more higher level languages, for example, the C programming language and similar general programming languages (such as Fortran, Basic, Javascript, PHP, Python, C++), knowledge programming languages (such as Lisp, Smalltalk, Prolog, or CycL), electronic structure programming languages (such as VHDL, Verilog, SPICE or SystemC), text programming languages (such as SGML, HTML, or XML), or audiovisual programming languages (such as SVG, MathML, X3D/VRML, or MIDI), and any future equivalent programming languages. As used herein, the term ‘source code’ signifies a set of instructions and data specified in text form using a programming language. A large amount of source code for use in enabling any of the claimed inventions is available on the Internet, such as from a source code library such as Github.

As used herein, the term ‘program’ (also referred to as an ‘application program’) signifies one or more processes and data structures that structure a module, processor, or computer to be used as a “specific machine” (see In re Alappat, 33 F3d 1526 [CAFC, 1991]). One use of a program is to structure one or more computers, for example, standalone, client or server computers, or one or more modules, or systems of one or more such computers or modules. As used herein, the term ‘computer application’ signifies a program that enables a specific use, for example, to enable text processing operations, or to encrypt a set of data. As used herein, the term ‘firmware’ signifies a type of program that typically structures a processor or a computer, where the firmware is smaller in size than a typical application program, and is typically not very accessible to or modifiable by the user of a computer. Computer programs and firmware are often specified using source code written in a programming language, such as C. Modules, circuits, processors, programs, and computers can be specified at multiple levels of abstraction, for example, using the SystemC programming language, and have value as products in commerce as taxable goods under the Uniform Commercial Code (see U.C.C. Article 2, Part 1).

A program is transferred into one or more memories of the computer or computer system from a data and information device or storage system. A computer system typically has a device for reading storage media that is used to transfer the program, and/or has an interface device that receives the program over a network. This transfer is discussed in the General Computer Explanation section.

### DETAILED DESCRIPTION—TECHNOLOGY SUPPORT GENERAL COMPUTER EXPLANATION

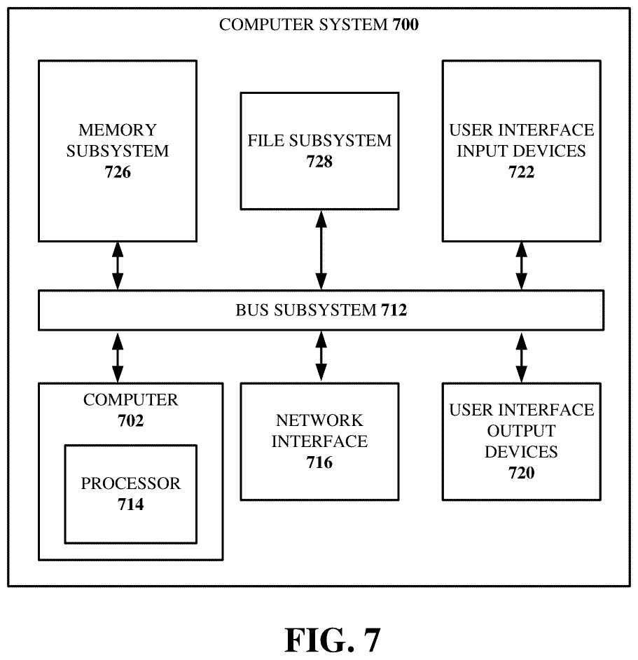

FIG. 7 depicts a computer system 700 suitable for enabling embodiments of the claimed inventions.

In FIG. 7, the structure of computer system 700 can include at least one computer 702 which communicates with peripheral devices via bus subsystem 712. Typically, the computer 702 includes a processor 714 (e.g., a microprocessor, graphics processing unit, AI co-processor or digital signal processor), or its electronic processing equivalents, such as an Application Specific Integrated Circuit (‘ASIC’) or Field Programmable Gate Array (‘FPGA’). Typically, peripheral devices include a storage subsystem, comprising a memory subsystem 726 and a file storage subsystem 728, user interface input devices 722, user interface output devices 720, and/or a network interface subsystem 716. The input and output devices enable direct and remote user interaction with computer system 710. The computer system enables significant post-process activity using at least one output device and/or the network interface subsystem.

The computer system can be structured as a server, a client, a workstation, a mainframe, a personal computer (PC), a tablet PC, a set-top box (STB), a personal digital assistant (PDA), a cellular telephone, a smartphone, a web appliance, a rack-mounted ‘blade’, a kiosk, a television, a game station, a network router, switch or bridge, or any data processing machine with instructions that specify actions to be taken by that machine. The term ‘server,’ as used herein, refers to a computer or processor that typically performs processes for, and sends data and information to, another computer or processor.

A computer system typically is structured, in part, with at least one operating system program, such as Microsoft's Windows, Sun Microsystems's Solaris, Apple Computer's MacOs and iOS, Google's Android, Linux and/or Unix. The computer system typically includes a Basic Input/Output System (BIOS) and processor firmware. The operating system, BIOS and firmware are used by the processor to structure and control any subsystems and interfaces connected to the processor. Typical processors that enable these operating systems include: the Pentium, Itanium, and Xeon processors from Intel; the Opteron and Athlon processors from Advanced Micro Devices; the Graviton processor from Amazon; the POWER processor from IBM; the SPARC processor from Oracle; and the ARM processor from ARM Holdings.

Any ECIN is limited neither to an electronic digital logic computer structured with programs nor to an electronically programmable device. For example, the claimed inventions can use an optical computer, a quantum computer, an analog computer, or the like. Further, where only a single computer system or a single machine is signified, the use of a singular form of such terms also can signify any structure of computer systems or machines that individually or jointly use processes. Due to the ever-changing nature of computers and networks, the description of computer system 710 depicted in FIG. 7 is intended only as an example. Many other structures of computer system 710 have more or less components than the computer system depicted in FIG. 7.

Network interface subsystem 716 provides an interface to outside networks, including an interface to communication network 718, and is coupled via communication network (not shown) to corresponding interface devices in other computer systems or machines. Communication network can comprise many interconnected computer systems, machines and physical communication connections (signified by ‘links’). These communication links can be wireline links, optical links, wireless links (e.g., using the WiFi or Bluetooth protocols), or any other physical devices for communication of information. Communication network can be any suitable computer network, for example a wide area network such as the Internet, and/or a local-to-wide area network such as Ethernet. The communication network is wired and/or wireless, and many communication networks use encryption and decryption processes, such as is available with a virtual private network. The communication network uses one or more communications interfaces, which receive data from, and transmit data to, other systems. Embodiments of communications interfaces typically include an Ethernet card, a modem (e.g., telephone, satellite, cable, or ISDN), (asynchronous) digital subscriber line (DSL) unit, Firewire interface, USB interface, and the like. Communication algorithms (‘protocols’) can be specified using one or communication languages, such as HTTP, TCP/IP, RTP/RTSP, IPX and/or UDP.

User interface input devices 722 can include an alphanumeric keyboard, a keypad, pointing devices such as a mouse, trackball, toggle switch, touchpad, stylus, a graphics tablet, an optical scanner such as a bar code reader, touchscreen electronics for a display device, audio input devices such as voice recognition systems or microphones, eye-gaze recognition, brainwave pattern recognition, optical character recognition systems, and other types of input devices. Such devices are connected by wire or wirelessly to a computer system. Typically, the term ‘input device’ signifies all possible types of devices and processes to transfer data and information into computer system 710 or onto communication network. User interface input devices typically enable a user to select objects, icons, text and the like that appear on some types of user interface output devices, for example, a display subsystem.

User interface output devices 720 can include a display subsystem, a printer, a fax machine, or a non-visual communication device such as audio and haptic devices. The display subsystem can include a cathode ray tube (CRT), a flat-panel device such as a liquid crystal display (LCD), an image projection device, or some other device for creating visible stimuli such as a virtual reality system. The display subsystem also can provide non-visual stimuli such as via audio output, aroma generation, or tactile/haptic output (e.g., vibrations and forces) devices. Typically, the term ‘output device’ signifies all possible types of devices and processes to transfer data and information out of computer system 710 to the user or to another machine or computer system. Such devices are connected by wire or wirelessly to a computer system. Note: some devices transfer data and information both into and out of the computer, for example, haptic devices that generate vibrations and forces on the hand of a user while also incorporating sensors to measure the location and movement of the hand. Technical applications of the sciences of ergonomics and semiotics are used to improve the efficiency of user interactions with any processes and computers disclosed herein, such as any interactions with regards to the design and manufacture of circuits that use any of the above input or output devices.

Memory subsystem 726 typically includes a number of memories including a main random-access memory (‘RAM’) 730 (or other volatile storage device) for storage of instructions and data during program execution and a read only memory (‘ROM’) 732 in which fixed instructions are stored. File storage subsystem 728 provides persistent storage for program and data files, and can include a hard disk drive, a floppy disk drive along with associated removable media, a CD-ROM drive, an optical drive, a flash memory such as a USB drive, or removable media cartridges. If computer system 710 includes an input device that performs optical character recognition, then text and symbols printed on paper can be used as a device for storage of program and data files. The databases and modules used by some embodiments can be stored by file storage subsystem 728.

Bus subsystem 712 provides a device for transmitting data and information between the various components and subsystems of computer system 710. Although bus subsystem 712 is depicted as a single bus, alternative embodiments of the bus subsystem can use multiple buses. For example, a main memory using RAM can communicate directly with file storage systems using Direct Memory Access (‘DMA’) systems.

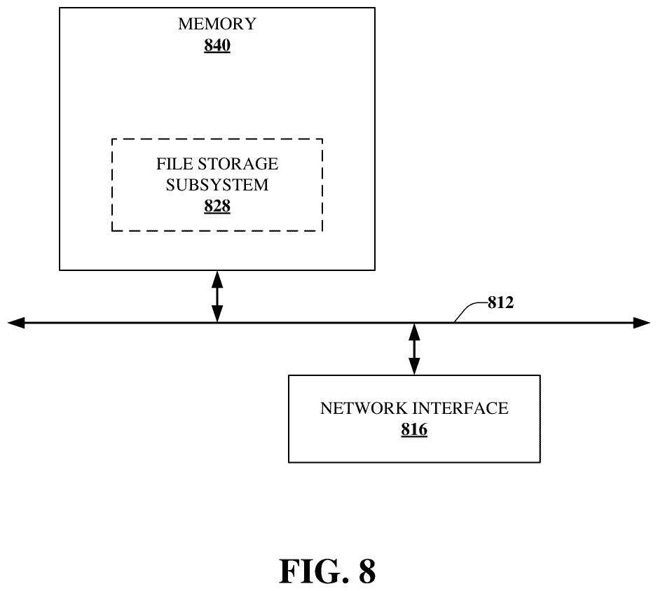

FIG. 8 illustrates a memory 840 such as a non-transitory, processor readable data and information storage medium associated with file storage subsystem 828, and/or with network interface subsystem 816, and can include a data structure specifying a circuit design. The components (e.g., memory 840, file storage subsystem 828, and network interface 816) can communicate via a bus 812. The memory 840 can be a hard disk, a floppy disk, a CD-ROM, an optical medium, removable media cartridge, or any other medium that stores computer readable data in a volatile or non-volatile form, such as text and symbols on a physical object (such as paper) that can be processed by an optical character recognition system. A program transferred in to and out of a processor from such a memory can be transformed into a physical signal that is propagated through a medium (such as a network, connector, wire, or circuit trace as an electrical pulse); or through a medium such as space or an atmosphere as an acoustic signal, or as electromagnetic radiation with wavelengths in the electromagnetic spectrum longer than infrared light).

### DETAILED DESCRIPTION—SEMANTIC SUPPORT

The signifier ‘commercial solution’ signifies, solely for the following paragraph, a technology domain-specific (and thus non-preemptive—see Bilski): electronic structure, process for a specified machine, manufacturable circuit (and its Church-Turing equivalents), or composition of matter that applies science and/or technology for use in commerce to solve an unmet need of technology.

The signifier ‘abstract’ (when used in a patent claim for any enabled embodiments disclosed herein for a new commercial solution that is a scientific use of one or more laws of nature {see Benson}, and that solves a problem of technology {see Diehr} for use in commerce—or improves upon an existing solution used in commerce {sec Diehr})—is precisely defined by the inventor(s) {see MPEP 2111.01 (9th edition, Rev. 08.2015)} as follows:

a) a new commercial solution is ‘abstract’ if it is not novel (e.g., it is so well known in equal prior art {see Alice} and/or the use of equivalent prior art solutions is long prevalent {see Bilski} in science, engineering or commerce), and thus unpatentable under 35 U.S.C. 102, for example, because it is ‘difficult to understand’ {see Merriam-Webster definition for ‘abstract’} how the commercial solution differs from equivalent prior art solutions; or

b) a new commercial solution is ‘abstract’ if the existing prior art includes at least one analogous prior art solution {see KSR}, or the existing prior art includes at least two prior art publications that can be combined {see Alice} by a skilled person {often referred to as a ‘PHOSITA’, see MPEP 2141-2144 (9th edition, Rev. 08.2015)} to be equivalent to the new commercial solution, and is thus unpatentable under 35 U.S.C. 103, for example, because it is ‘difficult to understand’ how the new commercial solution differs from a PHOSITA-combination/-application of the existing prior art; or

c) a new commercial solution is ‘abstract’ if it is not disclosed with a description that enables its praxis, either because insufficient guidance exists in the description, or because only a generic implementation is described {see Mayo} with unspecified components, parameters or functionality, so that a PHOSITA is unable to instantiate an embodiment of the new solution for use in commerce, without, for example, requiring special programming {sec Katz} (or, e.g., circuit design) to be performed by the PHOSITA, and is thus unpatentable under 35 U.S.C. 112, for example, because it is ‘difficult to understand’ how to use in commerce any embodiment of the new commercial solution.

### DETAILED DESCRIPTION—CONCLUSION

The Detailed Description signifies in isolation the individual features, structures, functions, or characteristics described herein and any combination of two or more such features, structures, functions or characteristics, to the extent that such features, structures, functions or characteristics or combinations thereof are enabled by the Detailed Description as a whole in light of the knowledge and understanding of a skilled person, irrespective of whether such features, structures, functions or characteristics, or combinations thereof, solve any problems disclosed herein, and without limitation to the scope of the Claims of the patent. When an ECIN comprises a particular feature, structure, function, or characteristic, it is within the knowledge and understanding of a skilled person to use such feature, structure, function, or characteristic in connection with another ECIN whether or not explicitly described, for example, as a substitute for another feature, structure, function, or characteristic.

In view of the Detailed Description, a skilled person will understand that many variations of any ECIN can be enabled, such as function and structure of elements, described herein while being as useful as the ECIN. One or more elements of an ECIN can be substituted for one or more elements in another ECIN, as will be understood by a skilled person. Writings about any ECIN signify its use in commerce, thereby enabling other skilled people to similarly use this ECIN in commerce.

This Detailed Description is fitly written to provide knowledge and understanding. It is neither exhaustive nor limiting of the precise structures described, but is to be accorded the widest scope consistent with the disclosed principles and features. Without limitation, any and all equivalents described, signified or Incorporated By Reference (or explicitly incorporated) in this patent application are specifically incorporated into the Detailed Description. In addition, any and all variations described, signified, or incorporated with respect to any one ECIN also can be included with any other ECIN. Any such variations include both currently known variations as well as future variations, for example any element used for enablement includes a future equivalent element that provides the same function, regardless of the structure of the future equivalent element.

It is intended that the domain of the set of claimed inventions and their embodiments be defined and judged by the following Claims and their equivalents. The Detailed Description includes the following Claims, with each Claim standing on its own as a separate claimed invention. Any ECIN can have more structure and features than are explicitly specified in the Claims.

What is claimed is:

1. A system comprising:
two Linear Feedback Shift Registers (two LFSRs) of an equal size in a number of bits, initialized at power up or reset to an initial condition, wherein the values of the two LFSRs are compared during each clock cycle and, if there is a mismatch, an error is reported and threat mitigation initiated.

2. The system of claim 1, wherein the two LFSRs emit respective measure and reference indicators that change continually.

3. The system of claim 2, wherein the respective measure and reference indicators are emitted as a series of pseudo-random values separated by a large Hamming distance between consecutive values.

4. The system of claim 1, wherein a first LFSR of the two LFSRs is a tracking LFSR, and wherein a second LFSR of the two LFSRs is a reference LFSR.

5. The system of claim 1, wherein the respective number of bits in the two LFSRs is 20 bits.

6. The system of claim 1, further comprising:
a binary counter comprising a same number of bits as the two LFSRs.

7. The system of claim 1, further comprising:
a lookup table that stores information indicative of anchor values and the number of bits in the two LFSRs.

8. The system of claim 7, wherein the anchor values are coordinated to occur at convenient clock counts.

9. The system of claim 1, wherein the two LFSRs comprise respective groups of register bits, and wherein register bits of the respective groups of register bits is assigned to a defined value according to a selected pattern.

10. The system of claim 9, wherein the defined value is a LogicOneBit or a LogicZeroBit.

11. A system comprising:
one Linear Feedback Shift Register (LFSR) and one binary counter of an equal size in a number of bits, initialized at power up or reset to an initial condition, wherein during each anchor time listed in a table of anchor times and expected values, the values of the LFSR is compared to an expected value from the list, and wherein, if there is a mismatch, an error is reported and threat mitigation initiated.

12. The system of claim 11, wherein the anchor times are coordinated to occur at defined clock counts.

13. The system of claim 11, wherein the system operates concurrently with a boot Finite State Machine (FSM), and wherein, based on the mismatch, operation of the boot FSM is halted.

14. The system of claim 11, wherein the LFSR is a tracking LFSR.

15. The system of claim 11, wherein the LFSR is a reference LFSR.

16. A system comprising:
two Linear Feedback Shift Register (LFSR) blocks and one binary counter block, all three blocks having an equal size in a number of bits, initialized at power up or reset to an initial condition, wherein the values of the two LFSRs are compared during each clock cycle and if there is a mismatch, an error is reported and threat mitigation initiated, wherein, during each anchor time listed in a table of anchor times and expected values, the value of either LFSR is compared to an expected value from the list, and wherein, if there is a mismatch, the error is reported and threat mitigation initiated.

17. The system of claim 16, wherein the two LFSRs emit respective measure and reference indicators that change constantly.

18. The system of claim 17, wherein the respective measure and reference indicators are emitted as a series of pseudo-random values separated by a large Hamming distance between consecutive values.

19. The system of claim 16, wherein a first LFSR of the two LFSRs is a tracking LFSR, and wherein a second LFSR of the two LFSRs is a reference LFSR.

20. The system of claim 16, wherein the two LFSRs comprise respective groups of register bits, and wherein register bits of the respective groups of register bits is assigned to a defined value according to a selected pattern.
